(19) United States
(12) Patent Application Publication
(10) Pub. No.: US 2026/0134380 A1
(43) Pub. Date: May 14, 2026

(54) UAV DELIVERY METHOD AND PROGRAM PRODUCT

(71) Applicant: Shenzhen Meituan Low Altitude Logistics Technology Co., Ltd., Guangdong (CN)

(72) Inventors: Ziqi YOU, Shenzhen (CN); Tianjian Chen, Shenzhen (CN); Meng Xu, Shenzhen (CN); Xiangyu Zhang, Shenzhen (CN); Bangyan Zhang, Shenzhen (CN); Xianping Yan, Shenzhen (CN)

(21) Appl. No.: 19/281,901

(22) Filed: Jul. 28, 2025

(30) Foreign Application Priority Data
Nov. 14, 2024 (CN) 2024116327642

(51) Int. Cl. G06Q 10/0833; G05D 1/667; G05D 101/00; G05D 105/20; G05D 109/20; G05D 111/30; G06Q 10/083; G06Q 10/0836; G06Q 10/0837; H04L 43/10; H04W 4/44; H04W 4/80

(52) U.S. Cl. CPC G06Q 10/0833; G05D 1/667; G06Q 10/08365; G06Q 10/0837; G06Q 10/0843; H04L 43/10; H04W 4/44; H04W 4/80; G05D 2101/22; G05D 2105/20; G05D 2109/20; G05D 2111/32

(57) ABSTRACT

A Unmanned Aerial Vehicle (UAV) delivery method is performed by the a cloud and includes: receiving a delivery order, where the delivery order includes a pickup address, a destination address, and recipient's contact information; generating a first sub-waybill and a second sub-waybill based on the pickup address and the destination address; issuing the first sub-waybill to a ground delivery system, where the first sub-waybill is used to transport goods corresponding to the delivery order from the pickup address to a first airport; issuing the second sub-waybill to a flight operation system of the first airport, to enable the flight operation system to dispatch a UAV to transport the goods from the first airport to a second airport, where a distance between the destination address and the second airport is less than a preset distance threshold; and sending a recipient notification message to a recipient based on the recipient's contact information.

### CROSS REFERENCE TO RELATED APPLICATION

This application is based upon and claims priority to Chinese Patent Application No. 2024116327642, filed on Nov. 14, 2024, the entire contents of which are incorporated herein by reference.

### FIELD OF TECHNOLOGY

This disclosure relates to the field of the logistics delivery technology and the unmanned driving technology, and in particular to a UAV delivery method and a program product.

### BACKGROUND

As the science and technology continue to advance and the logistics industry evolves, UAV (Unmanned Aerial Vehicle) delivery has emerged as an innovative logistics approach that is gaining increasing public attention. A UAV delivery solution mainly means a process in which the UAV is used to transport goods from a shipping location to a receiving location. This delivery method demonstrates significant advantages in improving logistics efficiency, reducing traffic congestion, and lowering carbon emissions.

However, despite a promising prospect of the UAV delivery, there are still some issues and challenges to be urgently addressed. For example, a plurality of countries and regions impose strict legal and regulatory restrictions on the use of the UAV, including regulations on a flight altitude, a flight zone, privacy protection, and the like, which limit large-scale application of the UAV delivery.

### SUMMARY

This disclosure provides a UAV delivery method and a program product, which at least partially reduces the impact of a restricted fly zone on the large-scale application of UAV delivery and expands an application scope of UAV transportation and delivery in a logistics scenario.

Other features and advantages of this disclosure become apparent from the following detailed description or may be learned through the practice of this disclosure.

According to one aspect of this disclosure, a UAV delivery method is provided, including: receiving a delivery order, where the delivery order includes a pickup address, a destination address, and recipient's contact information; generating a first sub-waybill and a second sub-waybill based on the pickup address and the destination address; issuing the first sub-waybill to a ground delivery system, where the first sub-waybill is used to transport goods corresponding to the delivery order from the pickup address to a first airport; issuing the second sub-waybill to a flight operation system of the first airport, to enable the flight operation system to dispatch a UAV to transport the goods corresponding to the delivery order from the first airport to a second airport, where a distance between the destination address and the second airport is less than a preset distance threshold; and sending a recipient notification message to a recipient based on the recipient's contact information.

According to another aspect of this disclosure, a UAV control method is provided, including: receiving heartbeat information sent by airport equipment of a current airport, where the heartbeat information is periodically sent by the airport equipment, and the current airport is the first airport or the second airport; updating a heartbeat record based on the heartbeat information and replying with determining information; determining a current operation condition category of the current airport based on the heartbeat record in a previous time window, where the operation condition category is used to indicate a network condition of the current airport; and issuing a throughput operation strategy corresponding to the operation condition category to a flight operation system of the current airport.

According to another aspect of this disclosure, a UAV delivery apparatus is provided, including an order receiving module, an order splitting module, a first sending module, a second sending module, and a third sending module.

The order receiving module is configured to receive a delivery order, the delivery order includes a pickup address, a destination address, and recipient's contact information.

The order splitting module is configured to generate a first sub-waybill and a second sub-waybill based on the pickup address and the destination address.

The first sending module is configured to issue the first sub-waybill to a ground delivery system. The first sub-waybill is used to transport goods corresponding to the delivery order from the pickup address to a first airport.

The second sending module is configured to issue the second sub-waybill to a flight operation system of the first airport, enabling the flight operation system to dispatch a UAV to transport the goods corresponding to the delivery order from the first airport to a second airport. A distance between the destination address and the second airport is less than a preset distance threshold.

The third sending module is configured to send a recipient notification message to a recipient based on the recipient's contact information.

According to another aspect of this disclosure, a UAV control apparatus is provided, including a heartbeat receiving module, a recording and reply module, a category determining module, and a strategy sending module.

The heartbeat receiving module is configured to receive heartbeat information sent by airport equipment of a current airport, where the heartbeat information is periodically sent by the airport equipment, and the current airport is the first airport or the second airport.

The recording and reply module is used to update a heartbeat record based on the heartbeat information and reply with determining information.

The category determining module is configured to determine a current operation condition category of the current airport based on a heartbeat record in a previous time window. The operation condition category represents a network condition of the current airport.

The strategy sending module is configured to issue a throughput operation strategy corresponding to the operation condition category to a flight operation system of the current airport.

According to another aspect of this disclosure, an electronic device is provided, including: a memory for storing instructions; and a processor for invoking the instructions stored in the memory to implement the above UAV delivery method or UAV control method.

According to another aspect of this disclosure, a computer-readable storage medium is provided, on which computer instructions are stored. When the computer instructions are executed by a processor, the above UAV delivery method or UAV control method is implemented.

According to another aspect of this disclosure, a computer program product is provided, which stores instructions. When the instructions are executed by a computer, the computer is enabled to implement the above UAV delivery method or UAV control method.

According to another aspect of this disclosure, a chip is provided, including at least one processor and an interface.

The interface is used to provide program instructions or data to the at least one processor.

The at least one processor is used to execute the program instructions to implement the above UAV delivery method or UAV control method.

In the UAV delivery method and program product provided in the embodiments of this disclosure, reasonable resource allocation and utilization are implemented by splitting the delivery order into the first sub-waybill and the second sub-waybill, which are handled separately by the ground delivery system and the flight operation system of the UAV. The ground delivery system is responsible for short-distance segments that may have flight restrictions, while the UAV is responsible for long-distance, direct-route transportation tasks. This not only leverages respective advantages but also improves the efficiency of an overall delivery network, significantly reducing the time spent in an intermediate transportation stage. The UAV delivery can bypass ground traffic restrictions particularly in congested urban environments, greatly enhancing a delivery speed. In the embodiment of this disclosure, the pickup address may be located in a no-fly zone or restricted fly zone. The ground delivery system is used to transport goods out of the no-fly zone or restricted fly zone to the first airport, greatly expanding a service range of the UAV delivery. Additionally, in the embodiment of this disclosure, airports are introduced for the UAVs, namely, the “first airport” and the “second airport”, providing safe locations for takeoff and landing of the UAVs, facilitating flight route planning and management, and preventing possible safety risks associated with the UAVs flying directly in complex urban environments. Furthermore, goods are transported at specific airports in a concentrated manner, reducing chances of the UAVs flying over densely populated regions, and further enhancing flight safety.

It should be understood that the above general description and the following detailed description are merely examples and explanation, and cannot limit this disclosure.

### BRIEF DESCRIPTION OF THE DRAWINGS

Drawings provided herein are incorporated into this specification and constitute a part of this specification. The drawings illustrate embodiments consistent with this disclosure and are used to explain principles of this disclosure together with this specification.

It is apparent that the drawings described below are merely some embodiments of this disclosure. For those skilled in the art, other drawings can be obtained based on these drawings without creative effort.

FIG. 1 is a schematic diagram of a UAV delivery scenario according to an embodiment of this disclosure;

FIG. 2 is a flowchart of a UAV delivery method according to an embodiment of this disclosure;

FIG. 3 is a flowchart of delivery order splitting according to an embodiment of this disclosure;

FIG. 4 is a flowchart of synchronized state information during UAV delivery according to an embodiment of this disclosure;

FIG. 5 is a flowchart of UAV loading during UAV delivery according to an embodiment of this disclosure;

FIG. 6 is a flowchart of another UAV delivery method according to an embodiment of this disclosure;

FIG. 7 is a flowchart of still another UAV delivery method according to an embodiment of this disclosure;

FIG. 8 is a flowchart of yet another UAV delivery method according to an embodiment of this disclosure;

FIG. 9 is a flowchart of a UAV control method according to an embodiment of this disclosure;

FIG. 10 is a flowchart of determining an operation condition category according to an embodiment of this disclosure;

FIG. 11 is another flowchart of determining an operation condition category according to an embodiment of this disclosure;

FIG. 12 is another flowchart of UAV control according to an embodiment of this disclosure;

FIG. 13 is a schematic diagram of a UAV delivery apparatus according to an embodiment of this disclosure;

FIG. 14 is a schematic diagram of a UAV control apparatus according to an embodiment of this disclosure; and

FIG. 15 is a structural block diagram of an electronic device according to an embodiment of this disclosure.

### DESCRIPTION OF THE EMBODIMENTS

To make objectives, technical solutions, and advantages of embodiments of this disclosure clearer, the technical solutions in the embodiments of this disclosure are described clearly and comprehensively below with reference to accompanying drawings. It is apparent that the described embodiments are only a part other than all of the embodiments of this disclosure. Components of the embodiments of this disclosure described and illustrated in the accompanying drawings can be arranged and designed with various configurations. Therefore, the following detailed description of the embodiments of this disclosure provided in the accompanying drawings is not intended to limit the scope of the claimed disclosure but merely represents selected embodiments of this disclosure. All other embodiments obtained by those skilled in the art based on the embodiments of this disclosure without creative effort fall within the scope of protection of this disclosure.

It should be noted that before the technical solutions disclosed in the embodiments of this disclosure are used, a user should be informed of a type, usage scope, and a usage scenario of personal information related in this disclosure through appropriate means in accordance with relevant laws and regulations and authorize the use of the personal information

In addition, it can be understood that data (including but not limited to the data itself, data obtaining, or usage) related to the technical solutions should comply with requirements of relevant laws, regulations, and related provisions.

Currently, with technological advancements and the maturity of the unmanned driving technology, UAVs have successfully been applied in a delivery field, and are commonly used for food delivery, express delivery, and the like.

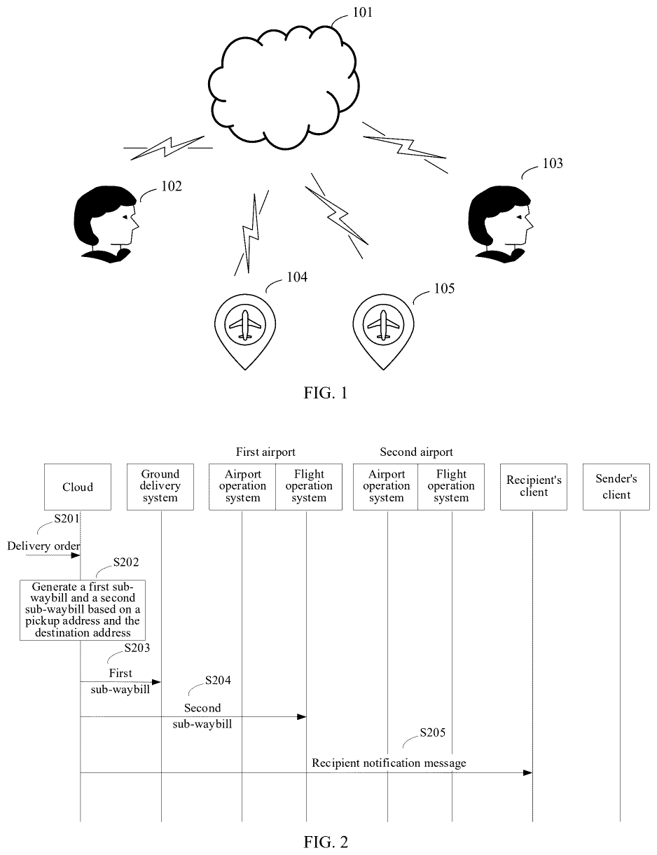

FIG. 1 is a UAV delivery scenario according to an embodiment of this disclosure. As shown in FIG. 1, the cloud 101 receives a delivery order indicating that goods at a sender 102 need to be transported to a recipient 103. In the embodiment of this disclosure, when the delivery order is performed, the delivery order is split into a first sub-waybill and a second sub-waybill, which are respectively used to transport goods from the sender 102 to a first airport and from the first airport 104 to a second airport 105. The second sub-waybill is transported using a UAV.

It should be noted that the delivery order may be sent to the cloud 101 by the sender 102 via a client, to the cloud 101 by the recipient 103 via a client, or to the cloud 101 by a third-party user via a client.

In some embodiments, the delivery order may include a pickup address, a destination address, and recipient's contact information. In some embodiments, the delivery order may also include sender contact information, goods information (such as a type, weight, and the like), and the like.

It can be understood that a client may be deployed in a terminal of the sender 102, a client may also be deployed in a terminal of the recipient 103, the first airport and the second airport may be provided with airport equipment, and an airport operation system and a flight operation system may be deployed in the airport equipment. The airport operation system may be used to distribute ground tasks to load goods onto a UAV. The flight operation system may be used to issue a flight instruction to the UAV and control a flight throughput and the like of the airport. The above airport operation system and/or flight operation system may be physically installed and run directly on the airport equipment or may be physically separate from the airport equipment, such as being installed and running on a cloud-based device and connected to the airport equipment via a communication system. The airport equipment provides information input to the airport operation system and/or flight operation system or executes instructions issued by the airport operation system and/or flight operation system. The airport operation system and/or flight operation system deployed in the airport equipment may be independent operation systems, subsystems of an integrated system, or collaborative systems of an airport operation system and/or a flight operation system deployed on the cloud.

FIG. 2 is a flowchart of a UAV delivery method according to an embodiment of this disclosure. As shown in FIG. 2, the UAV delivery method provided in this embodiment includes step S201 to step S205.

Step S201: The cloud receives a delivery order, where the delivery order includes a pickup address, a destination address, and recipient's contact information.

The delivery order may be sent to the cloud by a sender via a client, to the cloud by a recipient via a client, or to the cloud by a third-party user via a client, which is not limited herein.

In some embodiments, the delivery order may also include sender contact information, goods information (such as a type, weight, and the like), and the like.

Step S202: The cloud generates a first sub-waybill and a second sub-waybill based on the pickup address and the destination address.

In some embodiments, the cloud may invoke a route planning algorithm to calculate a shortest or fastest ground transportation route and aerial flight route based on the pickup address and the destination address, thereby determining a first airport and a second airport. The pickup address is then used as a starting address of the first sub-waybill, the first airport is used as a destination address of the first sub-waybill, so that the first sub-waybill is generated. Similarly, the second sub-waybill is generated based on the first airport and the second airport.

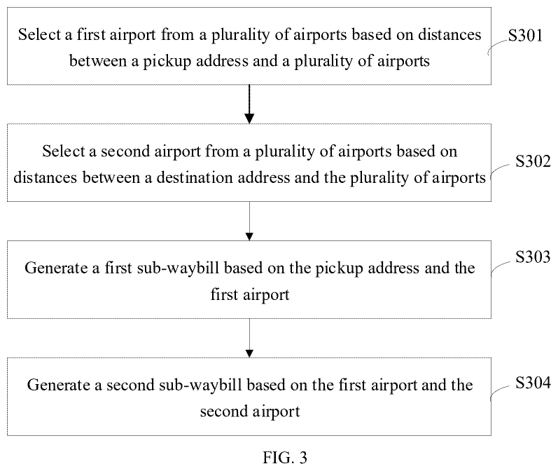

In some embodiments, as shown in FIG. 3, the generating a first sub-waybill and a second sub-waybill based on the pickup address and the destination address includes step S301 to step S304.

Step S301: Select the first airport from a plurality of airports based on distances between the pickup address and a plurality of airports;

Step S302: Select the second airport from the plurality of airports based on distances between the destination address and the plurality of airports;

Step S303: Generate the first sub-waybill based on the pickup address and the first airport; and

Step S304: Generate the second sub-waybill based on the first airport and the second airport.

In some embodiments, the cloud can store location information of the plurality of airports. During route planning, the above step S301 can involve matching the pickup address with several nearby airports as candidate airports for the first airport and then selecting the first airport based on factors such as flight throughputs of the candidate airports and storage locker compartment occupancy rates at the airports. Additionally, the first airport can alternatively be selected in combination with an order state and a transportation capacity of a ground delivery system. Specifically, an airport with an available UAV can be selected based on the flight throughput, an airport with a low occupancy rate can be selected based on the storage locker compartment occupancy rate, an airport with a logistically aligned order can be selected based on the order state and transportation capacity of the ground delivery system. In some embodiments, when there are available UAVs, the storage locker compartment occupancy rate is less than a preset threshold, and the transportation capacity of the ground delivery system meets delivery requirements, a fitness value can be calculated based on a quantity of the available UAVs, the storage locker compartment occupancy rate, and the transportation capacity of the ground delivery system. The first airport is selected from the candidate airports based on the fitness value that meets the above requirements.

In step S302, when the second airport is selected, different selection manners can be selected based on different delivery methods from the second airport to the recipient. When the delivery method from the second airport to the recipient is delivery through the ground delivery system, a selection method similar to the above selection method for the first airport can be used. When the delivery method from the second airport to the recipient is the recipient picking up goods directly from the second airport, the selection can be performed based on a distance between the second airport and the delivery address, a storage locker compartment occupancy rate at the second airport, and a method specified in the delivery order.

Step S203: The first sub-waybill is issued to the ground delivery system, and the first sub-waybill is used to transport goods corresponding to the delivery order from the pickup address to the first airport.

The delivery methods for the ground delivery system may include rider delivery, unmanned vehicle delivery, and a combination thereof, namely, a combination of the rider delivery and the unmanned vehicle delivery.

Step S204: The second sub-waybill is issued to the flight operation system of the first airport, to enable the flight operation system to dispatch a UAV to transport the goods corresponding to the delivery order from the first airport to the second airport, where a distance between the destination address and the second airport is less than a preset distance threshold.

Step S205: A recipient notification message is sent to the recipient based on the recipient's contact information.

In the embodiment of this disclosure, the delivery order is split into the first sub-waybill and the second sub-waybill and are assigned to the ground delivery system and a flight operation system of the UAV respectively, implementing reasonable allocation and utilization of resources. The ground delivery system is responsible for short-distance segments that may have flight restrictions, while the UAV is responsible for long-distance, direct-route transportation tasks. This not only leverages respective advantages but also improves the efficiency of an overall delivery network, significantly reducing the time spent in an intermediate transportation stage. The UAV delivery can bypass ground traffic restrictions particularly in congested urban environments, greatly enhancing a delivery speed.

In the embodiment of this disclosure, the pickup address may be located in a no-fly zone or restricted fly zone. The ground delivery system is used to transport goods out of the no-fly zone or restricted fly zone to the first airport, greatly expanding a service range of the UAV delivery. Additionally, in the embodiment of this disclosure, airports are introduced for the UAVs, namely, the “first airport” and the “second airport”, providing safe locations for takeoff and landing of the UAVs, facilitating flight route planning and management, and preventing possible safety risks associated with the UAVs flying directly in complex urban environments. Furthermore, goods are transported at specific airports in a concentrated manner, reducing chances of the UAVs flying over densely populated regions, and further enhancing flight safety.

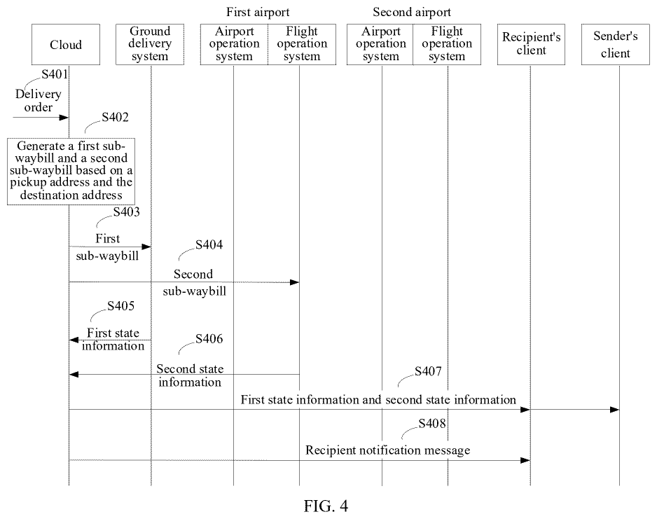

FIG. 4 is a flowchart of a UAV delivery method according to an embodiment of this disclosure. As shown in FIG. 4, the UAV delivery method provided in the embodiment of this disclosure includes step S401 to step S408. Step S401 to step S404 are the same as step S201 to step S204 in the above embodiment, and step S408 is the same as step S205 in the above embodiment, which is not described herein again.

Step S405: The cloud receives first state information feedback from a ground delivery system, where the first state information includes a progress of completing the first sub-waybill.

Step S406: The cloud receives second state information feedback from the flight operation system, where the second state information includes a progress of completing the second sub-waybill.

The cloud can receive the first state information (such as the progress of completing the first sub-waybill) feedback from the ground delivery system and the second state information (such as the progress of completing the second sub-waybill) feedback from the flight operation system in real time. This enables the cloud to comprehensively monitor a progress of each delivery stage and promptly find and address a potential issue.

In some embodiments, the above first state information and second state information may include receipt of goods, location information, order completion, task delay or blockage, and the like.

Step S407: The cloud synchronizes the first state information and second state information to a sender's client with a delivery order and/or a recipient's client with the delivery order.

In some embodiments, the second state information may also include event information during UAV flight and/or estimated landing time formation.

It should be noted that the above step S405 to step S407 are continuously performed during goods delivery until a corresponding task is completed. For example, after the first sub-waybill is completed, the first state information is no longer fed back.

In the embodiment of this disclosure, the cloud synchronizes these pieces of state information to the sender's client and the recipient's client, increasing transparency throughout the delivery process. The sender and the recipient can view a real-time state of the goods at any time, such as whether the goods have been transported from a pickup address, whether the goods have arrived at a first airport, or whether the UAV has started flying. The delivery state is updated in real time, so that the sender and the recipient can use the UAV delivery service with greater confidence, reducing anxiety and dissatisfaction caused by information asymmetry. In addition, timely information feedback can enhance overall user satisfaction, especially in cases of a delay or other issues, allowing the user to make preparation in advance and adjust a plan accordingly.

In some embodiments, the cloud can also optimize a delivery route based on historical first state information and/or historical second state information, thereby improving delivery efficiency and service quality. For example, the flight route between the first airport and the second airport can be optimized based on a plurality of pieces of second state information.

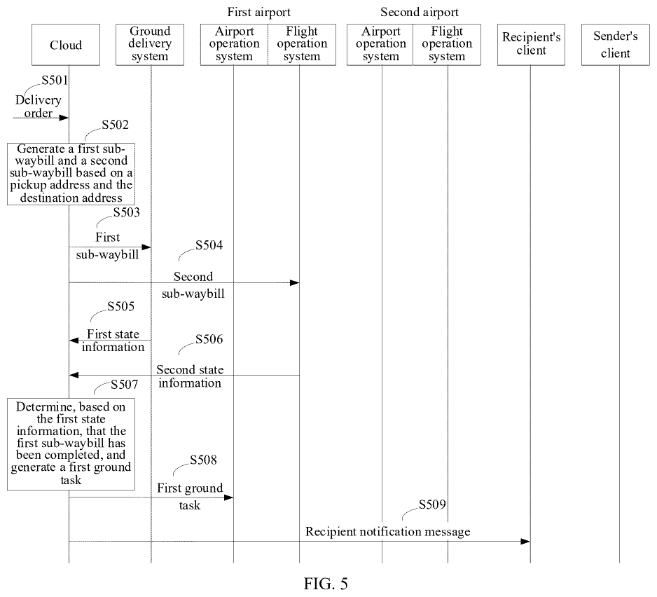

FIG. 5 is a flowchart of a UAV delivery method according to an embodiment of this disclosure. As shown in FIG. 5, the UAV delivery method provided in the embodiment of this disclosure includes step S501 to step S509. Step S501 to step S506 are the same as step S401 to step S406 in the above embodiment, and step S509 is the same as step S408 in the above embodiment, which is not described herein again.

Step S507: The cloud determines completion of the first sub-waybill based on the first state information and generates a first ground task.

When the first state information feedback from the flight operation system indicates that the first sub-waybill has been completed, the cloud generates the first ground task. In some embodiments, after a ground delivery system stores goods in a storage locker of a first airport, state information of completion of the first sub-waybill is automatically triggered and sent to the cloud. Specifically, the ground delivery system may be rider delivery. When a rider arrives at the first airport, the rider can open a storage locker compartment at the first airport via a client. A signal of opening the storage locker compartment is associated with the first sub-waybill. Subsequently, when a door of the storage locker compartment is closed, the state information of completion of the first sub-waybill is automatically triggered and sent to the cloud. It should be understood that the above solution for the storage locker compartment is merely an example of the embodiment of this disclosure. In actual execution, the goods may alternatively be placed in another storage device or designated location at the first airport, such as a specified logistics delivery box.

Step S508: The cloud issues the first ground task to an airport operation system of the first airport. The first ground task is used to load the goods corresponding to the delivery order onto a UAV.

The loading of goods onto the UAV can be automatically completed using an automated device, assisted by a rider from the ground delivery system, or assisted by staff at the first airport.

In the embodiment of this disclosure, after the first sub-waybill is completed, the first ground task can be promptly issued, thereby loading the goods onto the UAV and improving delivery efficiency.

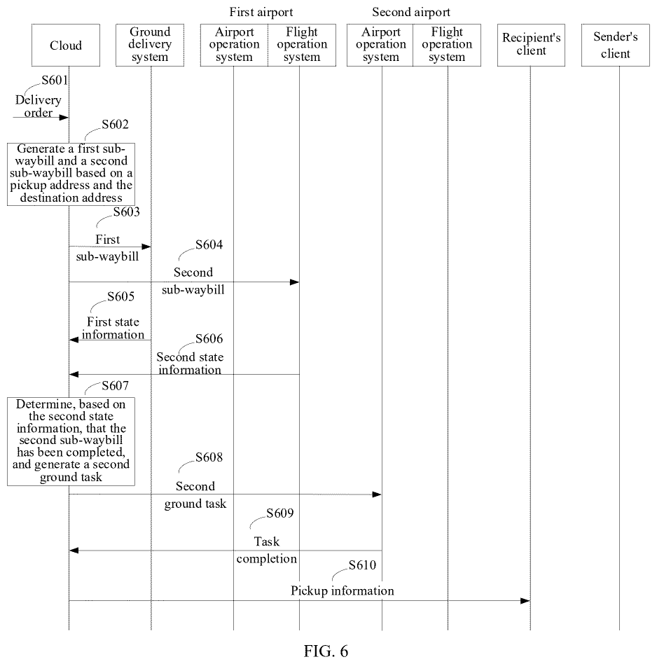

FIG. 6 is a flowchart of a UAV delivery method according to an embodiment of this disclosure. As shown in FIG. 6, the UAV delivery method provided in the embodiment of this disclosure includes step S601 to step S610. Step S601 to step S606 are the same as step S501 to step S506 in the above embodiment, which is not described herein again.

Step S607: Based on second state information, the second sub-waybill is determined to have been completed, and a second ground task is generated.

Step S608: The second ground task is issued to an airport operation system of a second airport, where the second ground task is used to store goods corresponding to the delivery order into a storage locker compartment at the second airport.

Step S609: Pickup information corresponding to the goods is generated in response to the goods corresponding to the delivery order being stored in the storage locker compartment at the second airport.

Step S610: The pickup information is sent to a recipient's client corresponding to the goods.

In the above embodiment, recipient notification message to a recipient based on recipient's contact information can involve sending the pickup information to a recipient's client corresponding to the goods. In the embodiment of this disclosure, after the goods arrive at the second airport, a temporary storage service can be provided to the recipient, and the recipient can be promptly notified of picking up the goods at the second airport. This allows the recipient to collect the goods in spare time, improving user satisfaction.

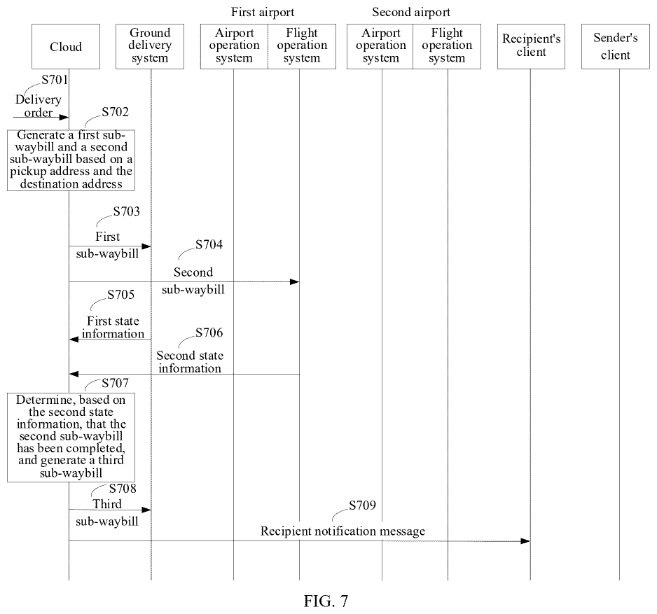

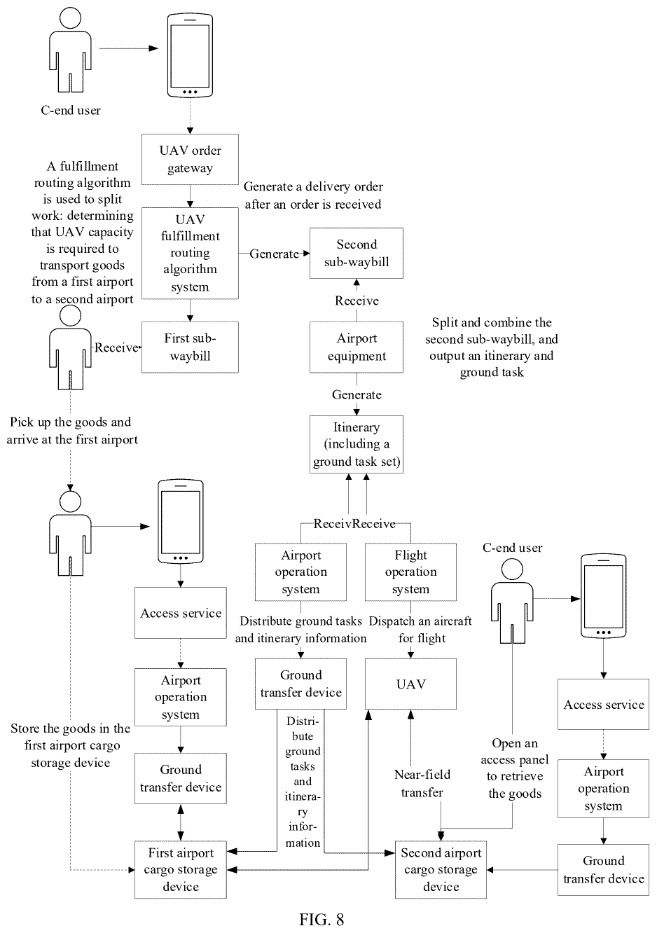

FIG. 7 is a flowchart of a UAV delivery method according to an embodiment of this disclosure. As shown in FIG. 7, the UAV delivery method provided in the embodiment of this disclosure includes step S701 to step S709. Step S701 to step S706 are the same as step S501 to step S506 in the above embodiment, and step S709 is the same as step S509 in the above embodiment, which is not described herein again.

Step S707: The second sub-waybill is determined to have been completed based on second state information, and a third sub-waybill is generated.

Step S708: The third sub-waybill is issued to a ground delivery system, and the third sub-waybill is used to transport goods corresponding to the delivery order from a second airport to a destination address.

In the embodiment of this disclosure, after the goods arrive at the second airport, the ground delivery system can be used to deliver the goods to the destination address, eliminating the need for a user to pick up the goods at the second airport, further improving user satisfaction.

In some embodiments, after the second sub-waybill is determined to have been completed based on the second state information, a recipient notification message can be sent to a recipient, and the recipient is prompted to choose a delivery method, such as selecting the delivery method of the embodiment in FIG. 6 or FIG. 7. Further, the above solution can involve sending a delivery request to a recipient's client corresponding to the goods after the second sub-waybill is determined to have been completed based on the second state information. If delivery response information returned by the recipient's client indicates delivery, the third sub-waybill is generated and issued to the ground delivery system. The third sub-waybill is used to transport the goods corresponding to the delivery order from the second airport to the destination address. If no delivery response information is received from the recipient's client or the received delivery response information indicates no delivery, a second ground task is generated and issued to an airport operation system of the second airport. The second ground task is used to store the goods corresponding to the delivery order into a storage locker compartment at the second airport. In response to the goods corresponding to the delivery order being stored in the storage locker compartment at the second airport, pickup information corresponding to the goods is generated and sent to the recipient's client corresponding to the goods.

In some embodiments, the cloud can also receive an order cancellation request, which is used to request the cancellation of a delivery order. In response to the order cancellation request, if it is determined based on the first state information that the goods in the delivery order have not yet been picked up from the pickup address, the order cancellation message is issued to the ground delivery system and the flight operation system of the first airport, enabling the ground delivery system to cancel the first sub-waybill and the flight operation system of the first airport to cancel the second sub-waybill.

FIG. 8 is a flowchart of a UAV delivery method according to an embodiment of this disclosure. As shown in FIG. 8, a C-end user can send a goods delivery request to a UAV order gateway via a client on a terminal device, and the cloud generates a delivery order after accepting the request. It should be noted that the client may be a shopping app client or a logistics delivery app client. The above C-end user may be a recipient, a sender, or a third-party personnel.

It should also be noted that the C-end user may select delivery by using a UAV when sending the above goods delivery request, such as selecting a second airport as a delivery address.

A UAV fulfillment routing algorithm system can split the above delivery order into a first sub-waybill and a second sub-waybill. In FIG. 8, a ground delivery system performs delivery by a rider. After accepting an order, the rider goes to a pickup address to pick up goods and stores the goods in a cargo storage device at a first airport. Once the goods are stored, the cargo storage device at the first airport automatically triggers state information indicating completion of the first sub-waybill.

Next, an airport operation system loads the goods onto a UAV dispatched by a flight operation system. The UAV flies to the second airport, and the goods are stored in a cargo storage device at the second airport. The C-end user opens the cargo storage device at the second airport via the client to retrieve the goods, and then an entire delivery process is completed. It can be understood that the C-end user herein means the recipient.

It should be noted that a ground transfer device in FIG. 8 may include a device such as a transport robot that can move goods. Additionally, airport equipment can split and combine the second sub-waybill, and output itineraries and ground tasks.

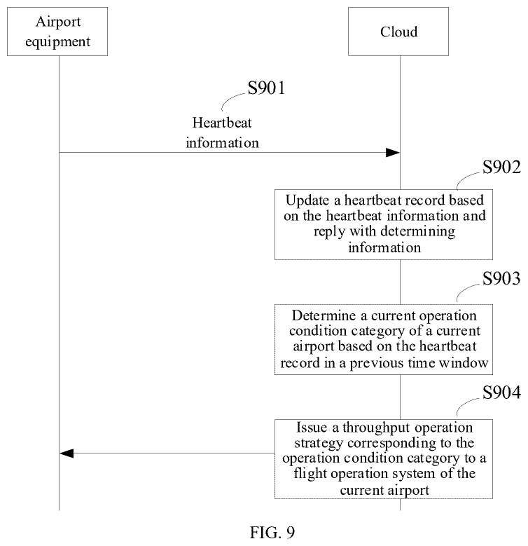

FIG. 9 is a flowchart of a UAV control method according to an embodiment of this disclosure. It should be noted that the UAV control method can be implemented based on the embodiments shown in FIG. 2 to FIG. 8 or implemented separately. The method is used to control a takeoff and landing frequency of UAVs at an airport and adjust a throughput of UAVs in a UAV delivery scenario at the airport, thereby improving UAV delivery safety. As shown in FIG. 9, the UAV control method includes step S901 to step S904.

Step S901: The cloud receives heartbeat information sent by airport equipment at a current airport, where the heartbeat information is periodically sent by the airport equipment, and the current airport is a first airport or a second airport.

Step S902: The cloud updates a heartbeat record based on the heartbeat information and replies with determining information.

Step S903: The cloud determines a current operation condition category of the current airport based on the heartbeat record in a previous time window, where the operation condition category represents a network condition of the current airport.

Step S904: The cloud sends a throughput operation strategy corresponding to the operation condition category to a flight operation system of the current airport.

In the above embodiment, the airport equipment may mean equipment provided at an airport to monitor a network condition or any equipment at the airport that can be connected to the cloud. There are numerous types of equipment at a UAV airport. An equipment failure or network interruption may lead to UAV task failure or safety risk. Based on periodical heartbeat information, the cloud can assess network stability and latency, promptly find a network issue and take measures to ensure the normal operation and data transmission of the UAV.

In some embodiments, the airport equipment may include a UAV base station, a charging station, a communication base station, and the like.

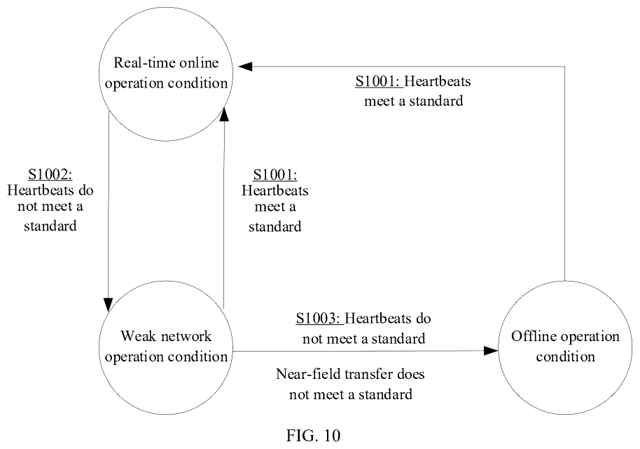

In some embodiments, as shown in FIG. 10, the operation condition category in step S903 may include a real-time online operation condition, a weak network operation condition, and an offline operation condition. Based on the heartbeat record in the previous time window, a current operation condition category of the current airport is determined as follows: if a quantity of lost heartbeats in the previous time window is less than a preset quantity (S1001), the current operation condition category of the airport is determined as the real-time online operation condition. If a quantity of lost heartbeats in the previous time window is greater than or equal to a preset quantity and an ongoing flight itinerary that has not been completed exists at the current airport (S1002), the current operation condition category of the current airport is determined as the weak network operation condition. If a quantity of lost heartbeats in the previous time window is greater than or equal to a preset quantity and an ongoing flight itinerary that has not been completed does not exist at the current airport (S1003), the current operation condition category of the current airport is determined as the offline operation condition.

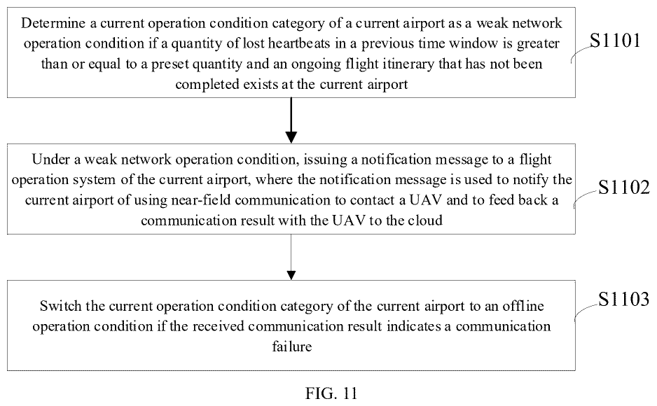

In some embodiments, as shown in FIG. 10, under the weak network operation condition, the cloud can make further determining in steps shown in FIG. 11, including step S1101 to step S1103.

Step S1101: A current operation condition category of the current airport is determined as a weak network operation condition if a quantity of lost heartbeats in a previous time window is greater than or equal to a preset quantity and an ongoing flight itinerary that has not been completed exists at a current airport.

Step S1102: Under the weak network operation condition, a notification message is sent to a flight operation system of the current airport, where the notification message is used to notify the current airport of using near-field communication to contact a UAV and to feed back a communication result with the UAV to the cloud.

Step S1103: If a received communication result indicates a communication failure, the current operation condition category of the current airport is switched to an offline operation condition.

In the embodiment of this disclosure, during a time window from a past moment T₋₁ to a current moment T₀, if a quantity of lost heartbeats is less than the preset quantity, the current operation condition category is determined as real-time online operation condition. Similarly, if the quantity of lost heartbeats exceeds the preset quantity, and an ongoing flight itinerary that has not been completed exists at the current airport, the current operation condition category of the airport is determined as the weak network operation condition. If an ongoing flight itinerary that has not been completed does not exist at the current airport, the current operation condition category of the airport is determined as the offline operation condition. Additionally, under the weak network operation condition, if the airport fails to contact the UAV using near-field communication, the operation condition is switched to the offline operation condition.

It can be understood that the process for determining the above operation condition is performed in real-time, and the real-time online operation condition, the weak network operation condition, and the offline operation condition can be switched between each other. For example, under the offline operation condition, T₋₁ during the time window from a past moment T₀ to a current moment, if it is detected that the quantity of lost heartbeats is less than the preset quantity, the operation condition category is switched from the offline operation condition to the real-time online operation condition.

In some embodiments, when the current operation condition category of the current airport is the real-time online operation condition, a throughput operation strategy corresponding to the operation condition category is to operate at maximum flight throughput. When the current operation condition category of the current airport is the weak network operation condition, a throughput operation strategy corresponding to the operation condition category is to reduce flight throughput. When the current operation condition category of the current airport is the offline operation condition, a throughput operation strategy corresponding to the operation condition category is to stop operation.

In the embodiment of this disclosure, under different operation condition categories, namely, different network conditions, different control strategies are used for the UAV at the airport. An airport flight throughput of the airport is controlled, and a flight frequency of the UAV is adjusted, to reduce safety risks.

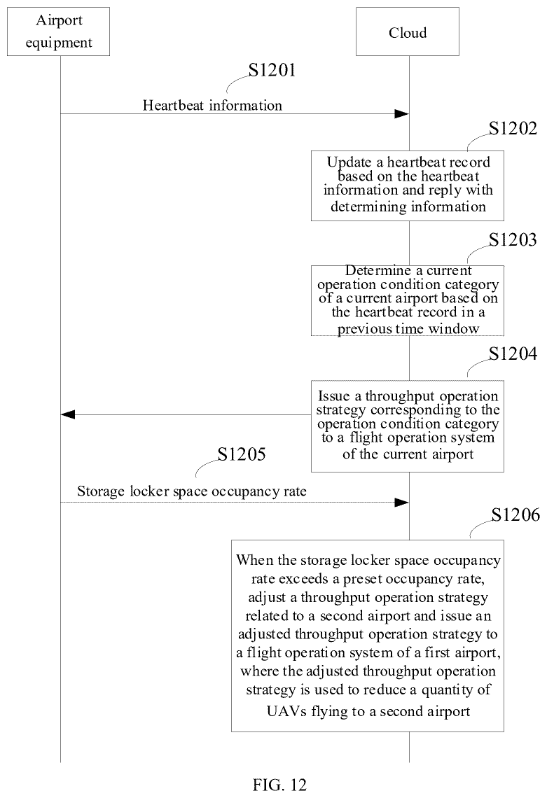

FIG. 12 is a flowchart of a UAV control method according to an embodiment of this disclosure. As shown in FIG. 12, the UAV control method provided in this embodiment includes step S1201 to step S1206. Step S1201 to step S1204 are the same as step S901 to step S904 in the above embodiment, which is not described herein again.

Step S1205: A storage locker space occupancy rate sent by an airport operation system of a second airport is received.

In some embodiments, when a compartment in a storage locker is occupied (goods are placed inside), the compartment is changed to an unavailable state. The storage locker contains a plurality of compartments, and a storage locker compartment occupancy rate can be calculated as a storage locker space occupancy rate.

Step S1206: When the storage locker space occupancy rate exceeds a preset occupancy rate, a throughput operation strategy related to the second airport is adjusted, and an adjusted throughput operation strategy is sent to a flight operation system of a first airport and is used to reduce a quantity of UAVs flying to the second airport.

In the embodiment of this disclosure, the flight throughput is adjusted based on the storage locker compartment occupancy rate at the airport, and a delivery route is planned accordingly. For example, a process of splitting a delivery order in a previous embodiment is adjusted, and a more suitable airport is selected for transportation, thereby reducing a waiting time period for goods at the airport.

It should also be noted that the steps in the embodiments shown in FIG. 9 to FIG. 12 and the steps in the embodiments shown in FIG. 2 to FIG. 8 are not sequentially related. Steps from any embodiment in FIG. 2 to FIG. 8 can be performed first, followed by steps from any embodiment in FIG. 9 to FIG. 12, or vice versa.

In some embodiments, the steps in the embodiment shown in FIG. 12 are performed first, followed by the steps in the embodiment shown in FIG. 2. In this way, during the process of generating the first sub-waybill and the second sub-waybill in step S202 based on the pickup address and destination address, throughput operation strategies of various airports can be referenced when the first airport and the second airport are selected. The solution for adjustment of the throughput operation strategies in the above embodiments can help the cloud better plan routes and improve delivery efficiency.

It should also be noted that a protocol between the cloud and a device end is designed in this embodiment of the disclosure, with specific content as follows:

Information sent by the cloud to the device end:
(1) Task distribution phase: the cloud sends a ground task to the device end, and since the device end and a machine end synchronize the ground task during near-field transfer, determining information receipt by the device end is not required;
(2) Task content update phase: the cloud sends task content update information to the device end, and determining information receipt by the device end is not required;
(3) Task cancellation phase: the cloud sends task cancellation information to the device end, and determining information receipt by the device end is not required; and
(4) Task execution phase: the cloud synchronizes in-flight event information, estimated landing time information, and the like, to the device end, and determining information receipt by the device end is not required.

Information sent from the device to the cloud:
(1) Task completion phase: the device end sends task completion information to the cloud, the cloud replies with determining information, the device retries if the sending fails; and after near-field transfer is completed, a machine also sends the task completion information to the cloud. However, considering a possibility of alternate landing or takeover during return flight, a redundant reply mechanism is established herein.
(2) Task failure phase: the device end sends task failure information to the cloud, the cloud replies with determining information, the device end retries if the sending fails, and after near-field transfer is completed, the machine also sends the task completion information to the cloud. However, considering a possibility of alternate landing or takeover during the return flight, a redundant reply mechanism is established herein.
(3) Task execution phase encountering a task blockage: The device end notifies the cloud of a task blockage, the cloud replies with determining information, the device end retries if the sending fails, blockage indicates that the device end believes the task needs a longer time period than a standard task completion time period. Implicitly, blockage suggests that the device believes a task is eventually successfully performed after the time period.
(4) Heartbeat information: the device end periodically sends heartbeat information to the cloud, the cloud replies with determining information, and the cloud uses a heartbeat record to determine a network condition of the device end.
(5) Device working state synchronization: the device end periodically sends information about whether there is a failure to the cloud, and determining information receipt by the cloud is not required.
(6) Auxiliary near-field transfer: the device end requests a runway identifier (runwayID) information from the cloud, the cloud responds to this message with the runwayID, and no further response is required.
(7) Dynamic service information synchronization: the device end periodically sends a compartment condition to the cloud, the cloud assists in fulfillment and flight scheduling based on compartment distribution/occupancy, and determining information receipt by the cloud is not required.
(8) Alarm: the device end sends an alarm code to the cloud, and the cloud replies with determining information.

It should be noted that the above device end includes a terminal device of a user (such as a sender and a recipient) and airport equipment.

In the embodiment of this disclosure, terms “first,” “second,” and “third” are used solely for descriptive purposes and should not be interpreted as indicating or implying relative importance.

The term “and/or” in this disclosure is merely for describing a relationship between associated objects, indicating that three types of relationships may exist. For example, “A and/or B” can mean: A exists alone, A and B exist together, or B exists alone. Additionally, a character “/” in this specification usually indicates an “or” relationship between preceding and following items that are associated.

In addition, although the steps of the method in this disclosure are described in a specific order in the accompanying drawings, this does not require or imply that these steps need to be performed in that specific order, or does not require or imply that these steps need to be performed to achieve a desired result.

In some embodiments, some steps may be omitted, a plurality of steps may be combined into a single step for execution, and/or a single step may be divided into a plurality of steps for execution.

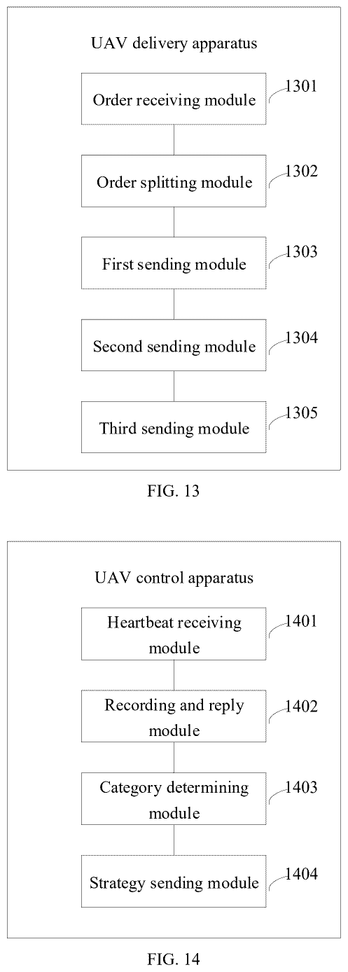

Based on the same inventive concept, an embodiment of this disclosure also provides a UAV delivery apparatus, as shown in FIG. 13. The UAV delivery apparatus includes an order receiving module 1301, an order splitting module 1302, a first sending module 1303, a second sending module 1304, and a third sending module 1305.

The order receiving module 1301 is configured to receive a delivery order, the delivery order includes a pickup address, a destination address, and recipient's contact information.

The order splitting module 1302 is configured to generate a first sub-waybill and a second sub-waybill based on the pickup address and the destination address.

The first sending module 1303 is configured to issue the first sub-waybill to a ground delivery system. The first sub-waybill is used to transport goods corresponding to the delivery order from the pickup address to a first airport.

The second sending module 1304 is configured to issue the second sub-waybill to a flight operation system of the first airport, enabling the flight operation system to dispatch a UAV to transport the goods corresponding to the delivery order from the first airport to a second airport. A distance between the destination address and the second airport is less than a preset distance threshold.

The third sending module 1305 is configured to send a recipient notification message to a recipient based on the recipient's contact information.

Based on the same inventive concept, an embodiment of this disclosure also provides a UAV control apparatus, as shown in FIG. 14. The UAV control apparatus includes a heartbeat receiving module 1401, a recording and reply module 1402, a category determining module 1403, and a strategy sending module 1404.

The heartbeat receiving module 1401 is configured to receive heartbeat information sent by airport equipment at a current airport. The heartbeat information is periodically sent by the airport equipment.

The recording and reply module 1402 is configured to update a heartbeat record based on the heartbeat information and reply with determining information.

The category determining module 1403 is configured to determine a current operation condition category of the current airport based on a heartbeat record in a previous time window. The operation condition category represents a network condition of the current airport.

The strategy sending module 1404 is configured to issue a throughput operation strategy corresponding to the operation condition category to a flight operation system of the current airport.

In some embodiments, the category determining module 1403 is configured to:
determine the current operation condition category of the current airport as a real-time online operation condition if a quantity of lost heartbeats in a previous time window is less than a preset quantity; determine the current operation condition category of the current airport as a weak network operation condition if a quantity of lost heartbeats in a previous time window is greater than or equal to a preset quantity and an ongoing flight itinerary that has not been completed exists at the current airport; or determine the current operation condition category of the current airport as an offline operation condition if a quantity of lost heartbeats in a previous time window is greater than or equal to a preset quantity and an ongoing flight itinerary that has not been completed does not exist at the current airport.

In some embodiments, under the weak network operation condition, the category determining module 1403 is further configured to: send a notification message to a flight operation system of the current airport, where the notification message is used to notify the current airport of using near-field communication to contact a UAV and feed back a communication result with the UAV to the cloud; and switch the current operation condition category of the current airport to the offline operation condition if a received communication result indicates a communication failure.

In some embodiments, when the current operation condition category of the current airport is the real-time online operation condition, a throughput operation strategy corresponding to the operation condition category is to operate at maximum flight throughput. When the current operation condition category of the current airport is the weak network operation condition, a throughput operation strategy corresponding to the operation condition category is to reduce flight throughput. When the current operation condition category of the current airport is the offline operation condition, a throughput operation strategy corresponding to the operation condition category is to stop operation.

In some embodiments, the UAV control apparatus further includes a strategy adjustment module.

The strategy adjustment module is configured to receive a storage locker space occupancy rate sent by an airport operation system of a second airport. When the storage locker space occupancy rate exceeds a preset occupancy rate, a throughput operation strategy related to the second airport is adjusted, and an adjusted throughput operation strategy is sent to a flight operation system of the first airport and is used to reduce a quantity of UAVs flying to the second airport.

Concepts “first”, “second”, and the like mentioned in the disclosure are only used to distinguish different apparatuses, modules, or units, and are not used to define an order or interdependence of functions performed by these apparatuses, modules, or units.

Regarding the UAV delivery apparatus and UAV control apparatus in the above embodiments, the specific ways in which each module performs operations have been described in detail in the embodiments of the UAV delivery method and UAV control method, which are not described herein again.

It should be noted that although several modules or units for action execution are mentioned in the detailed description above, such division is not mandatory.

In practice, according to implementations of this disclosure, features and functions of two or more modules or units described above may be implemented in a single module or unit. Conversely, the features and functions of a single module or unit described above may be further implemented by a plurality of modules or units.

Some block diagrams shown in the accompanying drawings represent functional entities, which are not necessarily corresponding to physically or logically independent entities. These functional entities can be implemented in the form of software, in one or more hardware modules or integrated circuits, or in different networks and/or processor apparatuses and/or microcontroller apparatuses.

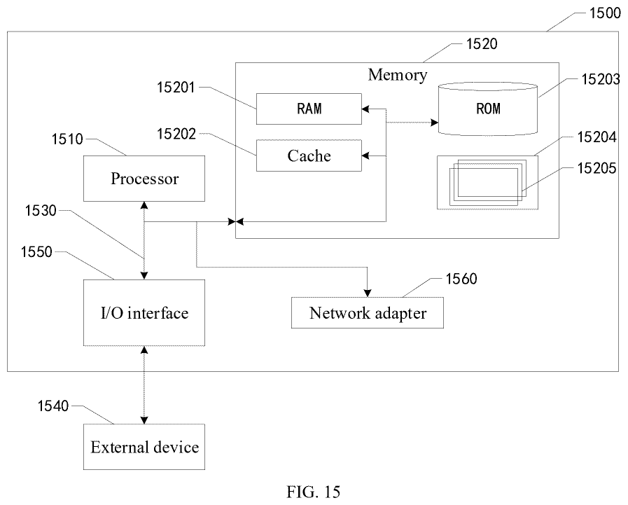

The following describes an electronic device provided in an embodiment of this disclosure with reference to FIG. 15. The electronic device 1500 shown in FIG. 15 is merely an example and should not impose any limitation on the functionality and scope of use of the embodiment of this disclosure.

FIG. 15 is a schematic diagram of an architecture of an electronic device 1500 according to an embodiment of this disclosure. As shown in FIG. 15, the electronic device 1500 includes but is not limited to: at least one processor 1510 and at least one memory 1520.

The memory 1520 is used for storing instructions.

In some embodiments, the memory 1520 may include a readable medium in the form of volatile memory units, such as a random access memory (RAM) 15201 and/or a cache memory unit 15202, and may further include a read-only memory (ROM) 15203.

In some embodiments, the memory 1520 may also include a program/utility 15204 with a set of (at least one) program modules 15205. Such program modules 15205 include but are not limited to: an operating system, one or more applications, other program modules, and program data, any of which or combinations thereof may include implementation for a network environment.

In some embodiments, the memory 1520 may store an operating system. The operating system may be a real-time operating system (Real Time eXecutive, RTX), LINUX, UNIX, WINDOWS, or an operating system like OS X.

In some embodiments, the memory 1520 may also store data.

For example, the processor 1510 may read data stored in the memory 1520. The data may be stored at the same memory address or at a different memory address as the instructions.

The processor 1510 is used to invoke the instructions stored in the memory 1520 to implement the steps of various “exemplary implementations” of this disclosure described in the exemplary method in this specification. For example, the processor 1510 may perform the steps of the above embodiments of the UAV delivery method or UAV control method.

It should be noted that the above processor 1510 may be a general-purpose processor or a specialized processor. The processor 1510 may include one or more processing cores and perform various functional applications and data processing by running instructions.

In some embodiments, the processor 1510 may include a central processing unit (CPU) and/or a baseband processor.

In some embodiments, the processor 1510 may determine an instruction based on a priority identifier and/or functional category information carried in each control instruction.

In this disclosure, the processor 1510 and the memory 1520 may be disposed separately or integrated.

For example, the processor 1510 and the memory 1520 may be integrated on a single board or a system-on-chip (SoC).

As shown in FIG. 15, the electronic device 1500 is presented in the form of a general-purpose computing device. The electronic device 1500 may also include a bus 1530.

The bus 1530 may represent one or more types of bus structures, including a memory bus or memory controller, a peripheral bus, a graphics acceleration port, a processor, or a local bus using any of a variety of bus architectures.

The electronic device 1500 may also communicate with one or more external devices 1540 (such as a keyboard, a pointing device, a Bluetooth device, and the like) and may also communicate with one or more devices that enable the user to interact with the electronic device 1500 and/or any devices (such as a router, a modem, and the like) that enable the electronic device 1500 to communicate with one or more other computing devices. Such communication may occur through an input/output (I/O) interface 1550.

Additionally, the electronic device 1500 may also communicate with one or more networks (such as a local area network (LAN), a wide area network (WAN), and/or a public network such as the Internet) through a network adapter 1560.

As shown in FIG. 15, the network adapter 1560 communicates with other modules of the electronic device 1500 through the bus 1530.

It should be understood that although not shown in the figure, other hardware and/or software modules may be used in conjunction with the electronic device 1500, including but not limited to: a microcode, a device driver, a redundant processing unit, an external disk drive array, an RAID system, a tape drive, and a data backup storage system.

It can be understood that the schematic structure illustrated in this disclosure does not constitute a specific limitation on the electronic device 1500. In some other embodiments of this disclosure, the electronic device 1500 may include more or fewer components than those shown in FIG. 15, some combined components or some split components, or have a different component arrangement. The components shown in FIG. 15 may be implemented in hardware, software, or a combination of hardware and software.

This disclosure also provides a computer-readable storage medium on which computer instructions are stored. When the computer instructions are executed by a processor, the UAV delivery method or UAV control method described in the above method embodiments is implemented.

In the embodiment of this disclosure, the computer-readable storage medium is capable of sending, propagating, or transmitting computer instructions for use by or in conjunction with an instruction execution system, device, or device.

For example, the computer-readable storage medium is a non-volatile storage medium.

In some embodiments, more specific examples of the computer-readable storage medium in this disclosure may include but are not limited to: electrical connections with one or more wires, a portable computer disk, a hard drive, a random access memory (RAM), a read-only memory (ROM), an erasable programmable read-only memory (EPROM or flash memory), an optical fiber, a portable compact disk read-only memory (CD-ROM), an optical storage device, a magnetic storage device, a USB drive, a portable hard drive, or any suitable combination of the above.

In the embodiment of this disclosure, the computer-readable storage medium may include data signals propagated in a baseband or as a part of a carrier wave, where the signals carry computer instructions (readable program code).

Such propagated data signals may be in various forms, including but not limited to an electromagnetic signal, an optical signal, or any suitable combination of the above.

In some examples, the computer instructions included in the computer-readable storage medium may be transmitted via any suitable medium, including but not limited to a wireless medium, a wired medium, an optical cable, RF, or the like, or any suitable combination of the above.

An embodiment of this disclosure also provides a computer program product, which stores instructions. When the instructions are executed by a computer, the computer is enabled to implement the UAV delivery method or UAV control method described in the above method embodiments.

The above instructions may be program code. During specific implementation, the program code may be written in any combination of one or more programming languages.

The programming languages include object-oriented programming languages such as Java, C++, and the like, as well as conventional procedural programming languages such as a “C” language or a similar programming language.

The program code may be executed entirely on a user's computing device, partially on the user's computing device, as a standalone software package, partially on the user's computing device and partially on a remote computing device, or entirely on a remote computing device or server.

When the remote computing device is involved, the remote computing device may be connected to a user computing device by any type of network, including a local area network (LAN) or a wide area network (WAN), or may be connected to an external computing device (for example, connected by using an Internet service provider via the Internet).

An embodiment of this disclosure also provides a chip, including at least one processor and an interface.

The interface is used to provide program instructions or data to the at least one processor.

The at least one processor is used to execute program instructions to implement the UAV delivery method or UAV control method described in the above method embodiments.

In some embodiments, the chip may also include a memory, which is used to store program instructions and data. The memory may be located inside or outside the processor.

Those skilled in the art can understand that all or part of the steps of the above embodiments can be specifically implemented in the following forms: a completely hardware-based implementation, a completely software-based implementation (including firmware, microcode, and the like), or a combination of hardware and software, which can collectively be referred to as a “circuit,” “module,” or “system.”

Those skilled in the art readily conceive other implementations of this disclosure upon considering this specification and practicing the invention disclosed herein.

This disclosure is intended to cover any variations, functions, or adaptive changes of this disclosure. These variations, functions, or adaptive changes comply with general principles of this disclosure, and include common knowledge or a commonly used technical means in the technical field that is not disclosed in this disclosure. This specification and the embodiments are merely considered as examples, and the actual scope and the spirit of this disclosure are described by the attached claims.

What is claimed is:

1. A Unmanned Aerial Vehicle (UAV) delivery method, wherein the method is performed by a cloud and comprises:
receiving a delivery order, wherein the delivery order comprises a pickup address, a destination address, and recipient's contact information;
generating a first sub-waybill and a second sub-waybill based on the pickup address and the destination address;
issuing the first sub-waybill to a ground delivery system, wherein the first sub-waybill is used to transport goods corresponding to the delivery order from the pickup address to a first airport;
issuing the second sub-waybill to a flight operation system of the first airport, to enable the flight operation system to dispatch a UAV to transport the goods from the first airport to a second airport, wherein a distance between the destination address and the second airport is less than a preset distance threshold; and
sending a recipient notification message to a recipient based on the recipient's contact information.

2. The method according to claim 1, wherein the method further comprises:
receiving first state information fed back by the ground delivery system, wherein the first state information comprises a completion progress of the first sub-waybill;
receiving second state information fed back by the flight operation system, wherein the second state information comprises a completion progress of the second sub-waybill; and
synchronizing the first state information and the second state information to a sender's client of the delivery order and/or to a recipient's client of the delivery order.

3. The method according to claim 2, wherein the method further comprises:
determining, based on the first state information, that the first sub-waybill has been completed, and generating a first ground task;
issuing the first ground task to an airport operation system of the first airport, wherein the first ground task is used to load the goods onto the UAV.

4. The method according to claim 2, wherein the method further comprises:
determining, based on the second state information, that the second sub-waybill has been completed, and generating a second ground task;
issuing the second ground task to an airport operation system of the second airport, wherein the second ground task is used to store the goods into a storage locker of the second airport;
in response to storing the goods into the storage locker of the second airport, generating pickup information corresponding to the goods;
sending the recipient notification message to the recipient based on the recipient's contact information comprises: sending the pickup information to the recipient's client corresponding to the goods.

5. The method according to claim 2, wherein the method further comprises:
determining, based on the second state information, that the second sub-waybill has been completed, and generating a third sub-waybill;
issuing the third sub-waybill to the ground delivery system, wherein the third sub-waybill is used to transport the goods from the second airport to the destination address.

6. The method according to claim 2, wherein the method further comprises:
receiving an order cancellation request, wherein the order cancellation request is used to request cancellation of the delivery order; and
in response to the order cancellation request and determining, based on the first state information, that the goods have not yet been picked up from the pickup address, issuing an order cancellation message to the ground delivery system and the flight operation system of the first airport, to enable the ground delivery system to cancel the first sub-waybill and the flight operation system of the first airport to cancel the second sub-waybill.

7. The method according to claim 2, wherein the second state information further comprises in-flight event information and estimated landing time information of the UAV.

8. The method according to claim 1, wherein generating the first sub-waybill and the second sub-waybill based on the pickup address and the destination address comprises:
selecting the first airport from a plurality of airports based on distances between the pickup address and the plurality of airports;
selecting the second airport from the plurality of airports based on distances between the destination address and the plurality of airports;
generating the first sub-waybill based on the pickup address and the first airport; and
generating the second sub-waybill based on the first airport and the second airport.

9. The method according to claim 1, wherein the method comprises:
receiving heartbeat information sent by airport equipment of a current airport, wherein the heartbeat information is periodically sent by the airport equipment, and the current airport is the first airport or the second airport;
updating a heartbeat record based on the heartbeat information and replying with determining information;
determining a current operation condition category of the current airport based on the heartbeat record in a previous time window, wherein the operation condition category is used to indicate a network condition of the current airport; and
issuing a throughput operation strategy corresponding to the operation condition category to a flight operation system of the current airport.

10. The method according to claim 6, wherein determining the current operation condition category of the current airport based on the heartbeat record in the previous time window comprises:
determining the current operation condition category of the current airport as a real-time online operation condition in response to a quantity of lost heartbeats in the previous time window being less than a preset quantity;
determining the current operation condition category of the current airport as a weak network operation condition in response to the quantity of lost heartbeats in the previous time window being greater than or equal to the preset quantity and an ongoing flight itinerary that has not been completed existing at the current airport; and
determining the current operation condition category of the current airport as an offline operation condition in response to the quantity of lost heartbeats in the previous time window being greater than or equal to the preset quantity and the ongoing flight itinerary that has not been completed not existing at the current airport.

11. The method according to claim 10, wherein the method further comprises:
in response to the current operation condition category of the current airport being the weak network operation condition, issuing a notification message to the flight operation system of the current airport, wherein the notification message is used to notify the current airport of using near-field communication to contact the UAV and to feed back a communication result with the UAV to the cloud; and
switching the current operation condition category of the current airport to the offline operation condition in response to the received communication result indicating a communication failure.

12. The method according to claim 10, wherein in response to the current operation condition category of the current airport being the real-time online operation condition, the throughput operation strategy corresponding to the operation condition category is to operate at maximum flight throughput;
in response to the current operation condition category of the current airport being the weak network operation condition, the throughput operation strategy corresponding to the operation condition category is to reduce flight throughput; and
in response to the current operation condition category of the current airport being the offline operation condition, the throughput operation strategy corresponding to the operation condition category is to stop operation.

13. The method according to claim 9, wherein the method further comprises:
receiving a storage locker space occupancy rate sent by an airport operation system of the second airport; and
in response to the storage locker space occupancy rate exceeding a preset occupancy rate, adjusting a throughput operation strategy related to the second airport and issuing an adjusted throughput operation strategy to the flight operation system of the first airport, wherein the adjusted throughput operation strategy is used to reduce a quantity of UAVs flying to the second airport.

14. A Unmanned Aerial Vehicle (UAV) delivery device, comprising:
a processor;
a transceiver; and
a memory, configured to store instructions excutable by the processor,
wherein the processor, upon executing the instruction, is configured to:
receive a delivery order, wherein the delivery order comprises a pickup address, a destination address, and recipient's contact information;
generate a first sub-waybill and a second sub-waybill based on the pickup address and the destination address;
issue the first sub-waybill to a ground delivery system, wherein the first sub-waybill is used to transport goods corresponding to the delivery order from the pickup address to a first airport;
issue the second sub-waybill to a flight operation system of the first airport, to enable the flight operation system to dispatch a UAV to transport the goods from the first airport to a second airport, wherein a distance between the destination address and the second airport is less than a preset distance threshold; and
send a recipient notification message to a recipient based on the recipient's contact information.

15. A computer program product, wherein the computer program product stores instructions, and when the instructions are executed by a computer, the computer is enabled to implement a UAV delivery method comprising:
receiving a delivery order, wherein the delivery order comprises a pickup address, a destination address, and recipient's contact information;
generating a first sub-waybill and a second sub-waybill based on the pickup address and the destination address;
issuing the first sub-waybill to a ground delivery system, wherein the first sub-waybill is used to transport goods corresponding to the delivery order from the pickup address to a first airport;
issuing the second sub-waybill to a flight operation system of the first airport, to enable the flight operation system to dispatch a UAV to transport the goods from the first airport to a second airport, wherein a distance between the destination address and the second airport is less than a preset distance threshold; and
sending a recipient notification message to a recipient based on the recipient's contact information.
